(19) United States
(12) Patent Application Publication
(10) Pub. No.: US 2026/0312111 A1
(43) Pub. Date: Oct. 8, 2026

(54) APPARATUS AND METHOD FOR THE ENERGY CELL MANUFACTURING INDUSTRY, IN PARTICULAR THE BATTERY CELL MANUFACTURING INDUSTRY, FOR WRAPPING A STACK

(71) Applicant: KÖRBER TECHNOLOGIES GMBH, HAMBURG (DE)

(72) Inventors: Jan KREYSERN, Hamburg (DE); Karsten MEINKE, Mölln (DE)

(21) Appl. No.: 19/470,392

(22) PCT Filed: Apr. 25, 2024
(86) PCT No.: PCT/EP2024/061406

§ 371 Date: Sep. 29, 2025

(30) Foreign Application Priority Data
Apr. 28, 2023 (DE) 10 2023 111 020.9

(51) Int. Cl. H01M 10/04; B65H 45/20

(52) U.S. Cl. CPC H01M 10/0404; B65H 45/20; H01M 10/0459

(57) ABSTRACT

The invention relates to an apparatus for the energy cell manufacturing industry for wrapping a stack comprising a plurality of segments and a material web. The apparatus is designed to form a stack with segments arranged in folds of the material web and to wrap said stack with the same material web. The invention also relates to a corresponding method.

The present invention relates to an apparatus for the energy cell manufacturing industry, in particular the battery cell manufacturing industry, for wrapping a stack comprising a plurality of segments and a material web, in particular a separator web. The apparatus is configured to form a stack with segments arranged in folds of the material web and to wrap said stack with the same material web, in particular a separator web. Furthermore, the invention relates to a method for the energy cell manufacturing industry, in particular the battery cell manufacturing industry, for wrapping a stack comprising a plurality of segments and a material web, in particular a separator web.

Known in principle from the prior art is the use of energy cells or even energy stores in motor vehicles, other land vehicles, ships, aircraft, or even in stationary systems in the form of battery cells or fuel cells, in which very large amounts of energy can be stored over longer periods of time. For this purpose, such energy cells have a structure composed of a plurality of segments stacked to form a stack, with a further material arranged between the segments. The segments can, for example, be designed as electrode sheets so that anode sheets and cathode sheets alternate in the stack. In such a case, a layer of a material web or separator web is arranged between two adjacent electrode sheets.

According to a first variant, the separators can be arranged in the form of individual separator sheets or material sheets between the electrodes. According to a second variant, it is also known to place the separator in the form of a material web around the segments by forming a z-shaped folding geometry, i.e., by a so-called Z-fold.

For forming the Z-fold, it is known in principle from the prior art to form the cell stack on a stacking table that is mounted so as to be movable horizontally. In a first placement position, an anode sheet is deposited onto a separator web stretched over the stacking table. By a movement of the stacking table in the horizontal direction to a second placement position, the separator web is placed or folded around the deposited anode sheet. In the second placement position, a cathode sheet is then deposited onto the separator web. By a horizontal movement of the stacking table back to the first placement position, the separator web is placed or folded around the cathode sheet so that an anode sheet can be deposited thereon again after the first placement position has been reached. This process is repeated until the desired cell stack height is reached, i.e., the cell stack is finished. In this way, the Z-fold mentioned at the beginning can be realized in manufacturing technology. Furthermore, it is known that the finished stack is wrapped with the same material web or separator web, which may negatively affect the production rate of the stacks.

It is an object of the present application to provide an improved apparatus for the energy cell manufacturing industry, in particular the battery cell manufacturing industry, for wrapping a stack comprising a plurality of segments and a material web, and to specify a correspondingly improved method.

The object is achieved by the features of the independent claims. Further preferred embodiments of the invention can be found in the dependent claims, the figures, and the associated description.

In order to achieve the object of the invention, an apparatus for the energy cell manufacturing industry, in particular the battery cell manufacturing industry, is proposed for wrapping a stack comprising a plurality of segments and a material web, in particular a separator web. The apparatus is configured to form a stack with segments arranged in folds of the material web and to wrap said stack with the same material web, in particular a separator web. It is proposed that the apparatus have a stacking table with a stacking position, on which the stack can be formed, and a wrapping apparatus with a wrapping position, wherein the stack can be wrapped with the same, continuous material web, in particular a separator web, on the wrapping position. It is furthermore proposed that the apparatus be configured to move the stack from the stacking position to the wrapping position, wherein the material web is extracted from a material web feed device by the movement of the stack from the stacking position in the direction of the wrapping position, forming a material web trailer, and to wrap the stack with the material web trailer of the material web in the wrapping position, wherein a separating device is provided, which is configured to separate the material web trailer from the material web of the material web feed device so that the material web trailer has a free end.

With the proposed apparatus, it is possible that the material web on the stacking table no longer needs to be moved as soon as a sufficient extraction of the material web or separator web beyond the stacking position is achieved by the movement of the stack in the direction of the wrapping position or by the movement of the stack to the wrapping position. The material web can therefore remain in position on the stacking table after extraction, so that no movement of the material web relative to the stacking table is necessary after separation until the new stack is completely built up. A new stack is started by depositing a segment, such as an anode sheet or cathode sheet, onto the material web. For this purpose, the stacking table is preferably movable vertically. The stacking table preferably moves downwards during the formation of the stack and returns to the starting position in contact with the material web after the removal of a completed stack. Accordingly, even after sufficient extraction to form the material web trailer, no realignment of the material web on the stacking table is necessary, so that depositing the first segment of the stack can be started. Furthermore, it is therefore also not necessary to pull back the material web on the stacking table. Directly after the formation of the material web trailer, it is preferably possible either to first separate the material web or to first start with the following stacking process before the material web is separated.

The stacking process can thus be resumed very quickly after a very short interruption, which increases the production rate of the apparatus in the manufacture of energy cells, in particular battery cells-for example, Li-ion batteries.

The wrapping of the stack with the same, continuous, i.e., one-piece, material web can thus be carried out during the already-started stacking process of the next stack. This not only increases throughput, but also allows more processing time for the wrapping process, so that higher quality can be achieved.

Preferably, the material web is separated before the first fold is formed on the first deposited segment. According to an advantageous embodiment, the material web is separated before the start of the formation of another stack by depositing a first segment. Separating the material web before the first fold can achieve that the separating device can be arranged very close to the stacking table, wherein a collision of the separating device during separation with other parts of the apparatus for depositing the segments and in particular a material web feed device for forming the first fold of the material web can simultaneously be avoided. The separating device is preferably arranged between the stacking position and the wrapping position.

The length of the material web intended for wrapping is preferably defined by the distance between the stacking position and the wrapping position, whereby the material web trailer is formed, and the position of the separating line of the separating device. In alternative advantageous embodiments, the length of the material web trailer can be set to be shorter if the stack is moved to an intermediate position in front of the wrapping position, and the material web is separated at the resulting length.

In advantageous embodiments, the apparatus comprises a trailer holding apparatus, which is configured to hold the material web trailer and/or the free end of the material web trailer by means of negative pressure.

The trailer holding apparatus is preferably designed in the form of a suction bar, which can suction and fix the material web and/or the material web trailer along a transverse line of the material web and/or the material web trailer.

In a preferred embodiment, the trailer holding apparatus is configured to hold the material web by means of negative pressure before it is separated by the separating device. This can achieve a defined positioning of the trailer holding apparatus relative to the material web trailer so that, after the material web has been separated, the free end of the material web trailer can be held directly by the trailer holding apparatus by means of negative pressure. The trailer holding apparatus is preferably configured to hold the material web trailer before and after the material web is separated, or to hold the free end of the material web trailer after the separation.

An uncontrolled and freely moving free end of the material web trailer is therefore avoided directly during the formation of the free end. For example, a very long material web trailer between the free end and the stack is therefore possible without process uncertainties being created by a loose material web. The material web can therefore be separated very close to the stacking table. It is therefore possible, for example, to form the material web trailer in a length range of the distance from the stacking position and the associated separating line to the wrapping position, and to use it in a controlled manner for wrapping.

The material web trailer is preferably separated between the trailer holding apparatus and the stacking table, so that the separating device is preferably arranged between the stacking table and the trailer holding apparatus. The separating device is preferably arranged in a stationary manner between the stacking position and the wrapping position, wherein the separating device is simultaneously vertically movable for performing the separating process, so that the moving mass is reduced, and a cable carrier for energy and data transmission can be dispensed with. In alternative embodiments, the separating device can be fastened to the trailer holding apparatus. In further alternative embodiments, the separating device can be fastened to the stacking table or to an element above the stacking table.

Preferably, the stacking table comprises a suction surface, which is configured to hold the material web by means of negative pressure. Accordingly, the material web can be temporarily fixed on the stacking table, which is advantageous after the material web trailer has been extracted and before the material web is separated. Therefore, in addition to the trailer holding apparatus, the stacking table can also hold the material web trailer so that the material web can be separated by the separating device when the material web is held on both sides of the separating line. In this way, sufficient tension of the material web can be maintained when separating the material web. Furthermore, the suction surface on the stacking table can prevent the material web from slipping on the stacking table. The position of the material web on the stacking table is therefore fixed. The material web can therefore preferably, before and after the separation, be fixed on the stacking table by the suction surface by means of negative pressure. Preferably, the proposed apparatus is configured such that the material web is fixed on the stacking table between the operating state immediately before the separation of the material web and the formation of the free end of the material web trailer until the movement of the finished stack in the direction of the wrapping apparatus. In this advantageous embodiment, there is therefore no movement of the material web relative to the stacking table after the separation of the material web until the end of stacking.

According to an advantageous embodiment, it is proposed that the trailer holding apparatus and/or the wrapping apparatus be configured to move the free end of the material web trailer and the wrapping position toward each other during wrapping of the stack with the material web trailer. In preferred embodiments, the wrapping apparatus is stationary, and only the trailer holding apparatus is moved in the direction of the wrapping apparatus.

Preferably, the trailer holding apparatus is configured to move the free end of the material web trailer with a constant web tension in the direction of the wrapping position during wrapping. The web tension can therefore be adjusted to the requirements of the wrapping progress. The wrapping apparatus can thereby advantageously rotate the stack about itself and pull the material web trailer accordingly, wherein the trailer holding apparatus can maintain sufficient web tension in the material web trailer and reposition the free end. For example, the wrapping apparatus can rotate the stack at a constant speed, and the trailer holding apparatus can be moved in the direction of the wrapping position at a non-linear speed. Due to the edges of the cuboid-like stack, there are discontinuities during wrapping. The rotational speed of the wrapping apparatus is therefore preferably coordinated with the speed of the trailer holding apparatus. It can therefore also be advantageous if neither the wrapping apparatus nor the trailer holding apparatus are moved at a constant speed. In a further advantageous embodiment, the trailer holding apparatus can be movable vertically, i.e., perpendicularly to the direction of the repositioning of the trailer, in order to compensate for the discontinuities during wrapping.

In a preferred embodiment, the separating device has a hot wire. With the separating device with the hot wire for separating the material web or separator web, the separating line or cutting edge can be arranged at a very small distance from the stacking table. The material web is preferably made of a polymer, which is separated by the thermal influence of the hot wire. Due to the very small distance between the separating line and the stacking table, the overhang of the material web on the stack can be minimized, so that the material web does not have to be pulled back after the separating process before the first segment for the next stack is deposited. This saves process time, and the position of the end of the material web can remain fixed and accordingly controlled at any time by the suction surface of the stacking table.

In an alternative advantageous embodiment, the separating device has an ultrasonic cutter. An ultrasonic cutter also makes it possible to arrange the separating line close to the stacking table. The required distance between the separating line and the stacking table is slightly larger than with the hot wire, but any thermal influence can be avoided with the ultrasonic cutter.

The separating device preferably separates the material web directly next to the stacking position so that the separating line is as close as possible to a new stack on the stacking table with a minimal overhang. The minimized overhang can be easily wrapped during later wrapping with the material web.

The distance between the separating line or cutting edge of the fed material web on the stacking table and the edge of the first segment on the material web of a new stack is preferably less than 50 mm, more preferably less than 25 mm, particularly preferably less than 10 mm. In particularly advantageous embodiments, the distance between the separating line or edge of the fed material web on the stacking table and the cutting edge of the first segment on the material web of a new stack is less than 5 mm. The resulting overhang of, for example, 4 mm can be wrapped easily.

Preferably, the apparatus comprises a fixing device, which is configured to fix the material web trailer wrapped around the stack by the wrapping apparatus. The material web trailer can be fixed, for example, with an adhesive strip.

Accordingly, the free end of the material web trailer can be fixed on the material web trailer already wrapped around the stack. The fixation can be achieved, for example, by application of an adhesive or an adhesive strip by the fixing device. The wrapped stack can thus finally be permanently fixed.

According to a further development, it is proposed that the apparatus have a conveyor carriage, which can be meshed with the stacking table for transferring the stack to the conveyor carriage and with the wrapping apparatus for transferring it to the wrapping apparatus.

This allows for easy transfer of the stack from the stacking table to the conveyor carriage. The stacking table is preferably vertically movable, so that the stacking table preferably descends for transfer, and the stack can be transferred to the conveyor carriage, which preferably meshes with the stacking table. The stacking table then preferably moves back up to a starting position.

In possible embodiments, the wrapping apparatus is vertically movable. After being moved to the wrapping position by means of the conveyor carriage, the stack can be transferred from the conveyor carriage to the wrapping apparatus-for example, by a meshing transfer. The wrapping apparatus and the conveyor carriage preferably mesh with each other so that an opposing vertical movement, e.g., by lowering the conveyor carriage or raising the wrapping apparatus, allows for a transfer in order to ensure that the stack is held seamlessly during the transfer.

Preferably, the conveyor carriage has a clamping lever, which is configured to clamp a stack onto the conveyor carriage. The clamping lever can, for example, be L-shaped, with one leg of the L-shaped clamping lever resting on the top of the stack. The stack is preferably clamped between the support surface of the conveyor carriage and the clamping lever so that a movement of the stack from the stacking position to the wrapping position on the conveyor carriage is possible without the segments and material web slipping relative to one another on the conveyor carriage.

In a preferred embodiment, the conveyor carriage is movable from the stacking position to the wrapping position, in particular transversely to the folds of a stack. This means that the conveyor carriage can preferably be moved from the stacking position to the wrapping position in a direction that is orthogonal to the course of the fold edges of the folds.

It is further proposed that the material web be able to be extracted from a material web feed device by the conveyor carriage, forming the material web trailer. This can in particular be achieved by clamping the stack on the conveyor carriage, whereby the corresponding tensile forces of the trailer on the stack, in particular on the upper part of the stack, can be absorbed without damaging the uppermost segment-for example, an anode. Furthermore, this allows for advantageous functional integration, since the stack can be conveyed to the wrapping apparatus at the same time as the material web trailer is extracted. The material web trailer can therefore preferably be pulled or carried along by the conveyor carriage.

According to a further development, it is proposed that the material web run over the empty stacking table as a result of the movement of the conveyor carriage to the wrapping position. After the material web trailer and the material web thereon have been fully extracted, this makes it possible for a subsequent stack to be stacked directly on the material web on the stacking table.

According to a possible embodiment, it is proposed that at least two conveyor carriages be fixed at the same distance from each other as the distance between the stacking position and the wrapping position. This allows the two conveyor carriages to be moved together by means of a common control, wherein the two conveyor carriages can be positioned simultaneously at the stacking position and at the wrapping position due to the corresponding distance. The second conveyor carriage is configured to remove the wrapped stack from the wrapping apparatus and to feed it to a further processing step for the production of an energy cell. The second conveyor carriage is preferably constructed in a similar manner and therefore preferably also has a corresponding clamping lever for securing the wrapped stack. In an alternative embodiment, two conveyor carriages can be controlled and moved separately from each other.

Furthermore, in order to achieve the object of the invention, a method for the energy cell manufacturing industry, in particular the battery cell manufacturing industry, is proposed for wrapping a stack comprising a plurality of segments and a material web, in particular a separator web. The following steps are proposed:
forming a stack with segments, arranged in folds of the material web, at a stacking position on a stacking table;
moving the stack from the stacking position to the wrapping position and extracting the material web from a material web feed device by the movement of the stack from the stacking position to the wrapping position, forming a material web trailer;
wrapping the stack with the material web trailer of the material web in the wrapping position by a wrapping apparatus;
separating the material web trailer from the material web of the material web feed device and producing a free end of the material web trailing part, wherein the stack is first wrapped and the material web is then separated, or wherein the material web is first separated and the stack is then wrapped, or wherein the material web is separated and the stack is wrapped at least partially in parallel.

Preferably, the proposed method is performed with a previously described apparatus—for example, according to one of claims 1 to 13.

In a preferred embodiment of the method, the start of the deposition of segments of a new stack onto the material web on the stacking table takes place before the start of the wrapping of the previous stack. This makes a high production rate possible, wherein sufficient time for wrapping is simultaneously available.

The separation takes place after the stack has been moved, and the material web trailer has been extracted. Furthermore, the separation preferably takes place before the stack is wrapped with the material web trailer.

According to a further development, the following method step is proposed:
holding the material web by a trailer holding apparatus.

According to a further, advantageous, development, the following method step is proposed:
holding the material web by a suction surface of a stacking table.

Preferably, the material web trailer is separated from the material web of the material web feed device as soon as the material web is held by the trailer holding apparatus and by the suction surface of the stacking table, wherein the separation takes place between the suction surface of the stacking table and the trailer holding apparatus.

Further preferably, during wrapping of the stack with the material web trailer, the free end of the material web trailer and the wrapping position are moved relative to each other, preferably horizontally and vertically, by moving the trailer holding apparatus and/or the wrapping apparatus. This makes it possible for the particular stack to be wrapped with the material web trailer with a free end of the material web trailer being controlled at all times, wherein the tension of the material web trailer can be maintained by the moving trailer holding apparatus for complete wrapping.

The effects and advantages associated with the method are consistent with the effects and advantages of the apparatus proposed above.

The invention is explained below using preferred embodiments with reference to the accompanying figures, in which:

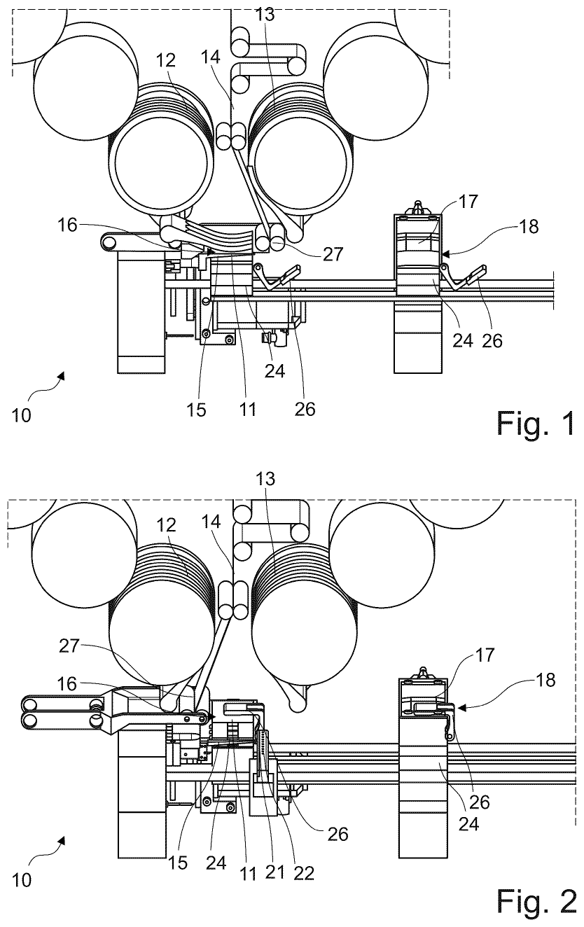

FIGS. 1 to 6 show an apparatus for wrapping a stack for an energy cell with a material web in various operating situations.

FIGS. 1 to 6 show an exemplary embodiment of an advantageous apparatus 10 for wrapping a stack 11 for producing an energy cell, in particular a battery cell—for example, a Li-ion battery. In the upper region, the apparatus 10 has a feed for segments 12, 13, which can in particular be electrode sheets. Electrode sheets are, for example, anode sheets or cathode sheets that have a conductor foil with a conductor tab, which in turn are coated with active anode or cathode material. For the production of an energy cell, different segments 12, 13, as shown in the figures, are fed from the left and right, via rotatably mounted bodies, to the stacking position 16. Furthermore, a preferably endless material web 14, in particular made of a separator material, is fed. The segments 12, 13 are alternately stacked in folds of the material web 14 to form a stack 11. The material web 14 can in particular be a separator web, which separates the different segments 12, 13 and, in the case of an ion battery, makes ion transfer possible.

In this exemplary embodiment, the stack 11 starts with the material web 14 as the lowermost layer on the stacking table 15. The segments 12, 13 are then stacked individually and alternately on the stacking table 15 of the apparatus 10, wherein, after each deposited segment 12, 13, the material web 14 is placed over the particular segment 12, 13 by a material web feed device 27 so that the individual segments 12, 13 are covered on both sides by a fold of the material web 14. This results in a stack 11 on the stacking table 15 for the production of an energy or battery cell with a so-called Z-fold.

The apparatus 10 serves to wrap such a formed stack with the material web 14 as efficiently as possible, to convey it further, and to allow for an overall high production rate, which is explained below with reference to various operating situations in FIGS. 1 to 6.

FIG. 1 shows the start of a first stack 11, which, in this exemplary embodiment, does not have a precursor stack for the sake of simplicity. The stacking table 15 is located at a stacking position 16, on which segments 12, 13 and the material web 14 are stacked. For this purpose, the stacking table 15 is preferably lowered as the height of the stack 11 increases. In FIG. 1, a final segment 12 is deposited onto the stack 11. In this state, the web path of the material web 14 is located on the right side of the illustration, wherein the material web feed device 27, which is located at the right position in FIG. 1, moves the web path of the material web 14 and thus the exit of the material web 14 between the two sides of the stack 11, where the folds are formed in each case.

In the transition to the operating state of FIG. 2, the material web 14 is folded to the left over the stack 11 by the movement of the material web feed device 27 and thus covers the uppermost layer of the stack 11—for example, a segment 12. Furthermore, a final layer, e.g., a segment 13, can be deposited on top, the covering of which by the material web 14 does not take place until during wrapping. Accordingly, the stack 11 has the intended number of segments 12, 13 and is thus finished.

FIG. 2 shows the apparatus 10 with a finished stack 11 on the stacking position 16. In this state, the stacking table 15 is lowered, and the stack 11 rests on the conveyor carriage 24, which is made possible by meshing or engaging, via fork-like elements, the stacking table 15 with the conveyor carriage 24. The conveyor carriage 24 comprises a clamping lever 26, which is L-shaped and is rotatably fixed at one end to the conveyor carriage 24. In the transition from the operating state of FIG. 1 to FIG. 2, the free leg of the L-shaped clamping lever 26 is moved to the uppermost layer of the stack 11, i.e., the material web 14, so that the stack 11 is fixed on the conveyor carriage 24 in the stacking position 16 with the clamping lever 24. The stacking table 15 is lowered further in order to clear the way for the conveyor carriage 24. The conveyor carriage 24 then moves with the stack 11 from the stacking position 16 in the direction of the wrapping position 18.

Furthermore, FIG. 2 shows the trailer holding apparatus 22, which in this operating state is positioned laterally to the region between the stacking position 16 and the wrapping position 18 and is movable laterally into this region. In alternative exemplary embodiments, the trailer apparatus can also be moved from below to the material web. The trailer holding apparatus 22 is provided with a negative pressure connection, so that the material web 14 can be held by means of negative pressure on the trailer holding apparatus 22—for example, on a suction bar.

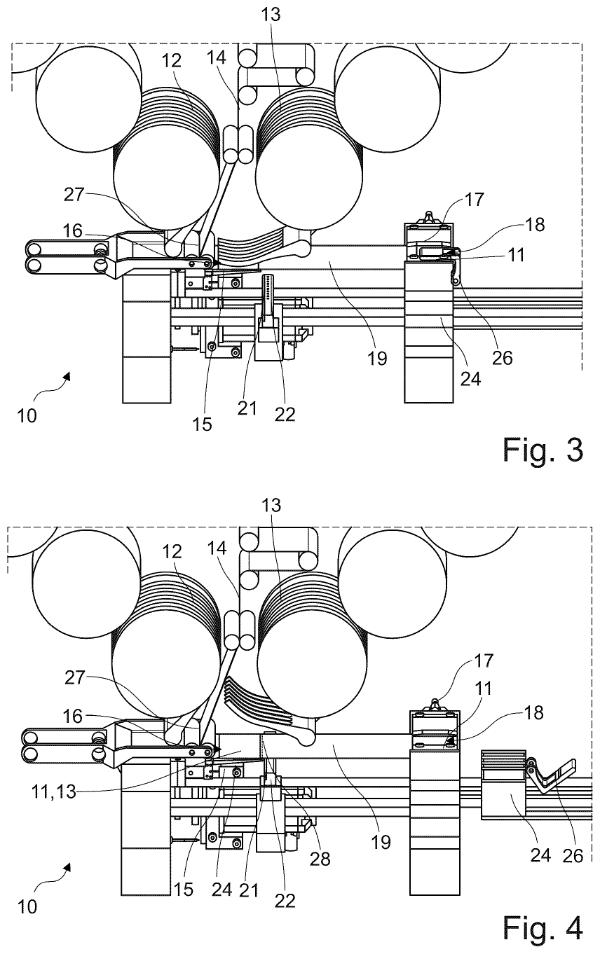

FIG. 3 shows the apparatus 10 in an operating state in which the stack 11 has been conveyed to the wrapping position 18. In alternative exemplary embodiments, the stack 11 can also first be moved in the direction of the wrapping position 18 to an intermediate position between the stacking position 16 and the wrapping position 18. This can be advantageous, since the wrapping position 18 does not have to be realigned if the length of the trailer changes. The material web 14 has been pulled by the movement of the conveyor carriage 24, whereby it is stretched in the form of a material web trailer 19 between the stack 11 on the wrapping position 18 or, where applicable, on the intermediate position and the feed of the material web 14 by the material web feed device 27—in this exemplary embodiment in FIG. 3, to the left of the stacking table 15. The material web 14 is therefore directly prepared above the wrapping table 15 as the lowermost layer of the subsequent stack 11, and the necessary material web trailer 19 of the material web 14 for wrapping the stack 11 on the wrapping position 18 is located between the wrapping position 18 and the stacking position 16. In possible exemplary embodiments, the length of the material web trailer 19 can be adjusted by the movement of the stack 11 in the direction of the wrapping position 18, in that the stack 11 is first conveyed on the conveyor carriage 24 to an intermediate position in front of the wrapping position 18, and the material web 14 is then separated at this length. In this case, the stack 11 is not conveyed to the wrapping position 18 until after separation.

In the operating state of FIG. 3, the stacking table 15 is raised back to the starting position, and the deposition of the first segment 13 onto the material web 14 on the stacking table 15 can start immediately, as shown in FIG. 3.

FIG. 4 shows how the trailer holding apparatus 22 is moved from the side or from below into the region between the stacking position 16 and the wrapping position 18 and is raised to such an extent that the trailer holding apparatus 22 comes into contact with the material web trailer 19, and the material web trailer 19 can be fixed with negative pressure. In advantageous exemplary embodiments, a suction surface is provided on the stacking table 15 and also holds the pulled material web 14 by means of negative pressure. With a separating device 21, which in this advantageous exemplary embodiment is arranged between the stacking table 15 and the trailer holding apparatus 22, the material web trailer 19 is cut or separated between the trailer holding apparatus 22 and the stacking table 15 as closely as possible to the stack 11 at a separating line 28. In this advantageous exemplary embodiment, the resulting free end of the material web trailer 19 is held by the trailer holding apparatus 22 before, during, and after the separation. Furthermore, in this advantageous exemplary embodiment, the other created end of the material web 14 is also held by means of negative pressure on the stacking table 15 before, during, and after the separation.

The separation or cutting of the material web 14 is therefore preferably carried out when the material web trailer 19 is at a standstill. Furthermore, the separation preferably takes place when the material web 14 is held on both sides of the separating line 28. The resulting free end 25 is held by the trailer holding apparatus 22.

Furthermore, the stack 11 in FIG. 4 is transferred from the conveyor carriage 24 to the wrapping apparatus 17, preferably by meshing or engaging, via fork-like elements, the wrapping apparatus 17, and the conveyor carriage 24 and, for example, by raising or lowering the wrapping apparatus 17. For this purpose, the clamping of the stack 11 on the conveyor carriage 24 by the clamping lever 26 is released by swinging out the clamping lever 26. In order to avoid a collision during the rotation of the stack 11 by the wrapping apparatus 17, the conveyor carriage 24 is moved out of the region of the wrapping apparatus 17—for example, to the right in FIG. 4.

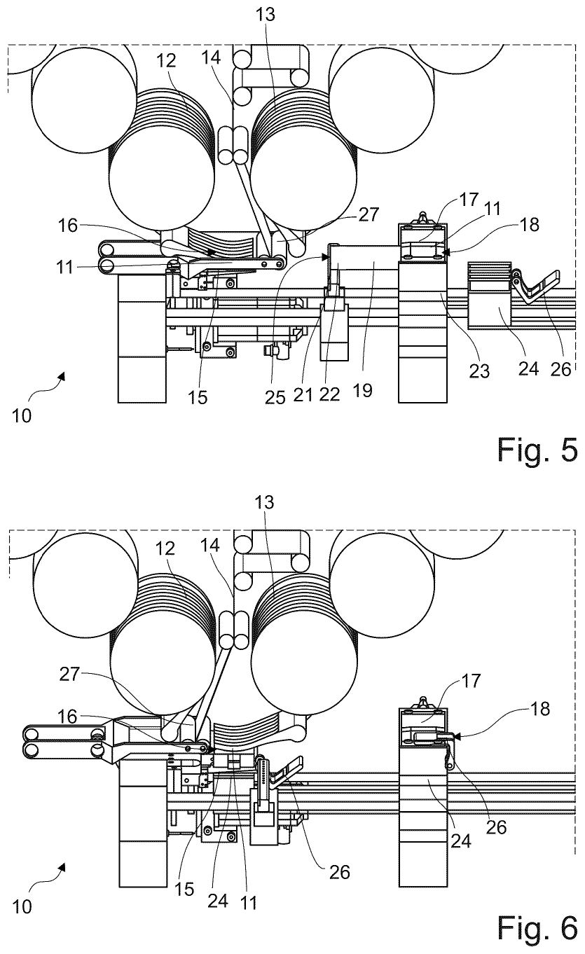

FIG. 5 shows the apparatus 10 in an operating state in which the stack 11 is wrapped onto the material web trailer 19 by the wrapping apparatus 17 at the wrapping position 18. Accordingly, the formation of a stack 11 and the wrapping of another stack 11 take place simultaneously at different positions 16, 18.

The free end of the material web trailer 19 is guided during the wrapping process by the trailer holding apparatus 22 while maintaining sufficient web tension, so that the trailer holding apparatus 22 moves toward the wrapping apparatus 17. This happens at the same time as the subsequent stack 11 is formed on the stacking position 16.

The material web trailer 19 wrapped around the stack 11 is fixed by a fixing device 23 at the trailer holding apparatus 22, preferably by means of an adhesive-for example, an adhesive strip.

In a final step, which is shown in FIG. 6, the wrapped stack 11 is conveyed away from the wrapping apparatus 24. The first conveyor carriage 24, which has transferred the stack 11 to the wrapping apparatus 17, has, as can be seen in FIG. 6, moved to the stacking position 16 in the meantime in order then to be able to take the following stack 11, analogously to the operating state of FIG. 1.

In a further alternative sequence of the stacking process with the apparatus 10, the first segment 13, e.g., an anode sheet, can be deposited from the right onto the material web 14, in particular a separator web, onto the stacking table 15. The material web 14 is then folded over the first and lowermost segment 13 of the stack 11 by the movement of the material web feed device 20. The next segment 12, e.g., a cathode sheet, can then be deposited from the left. The stack 11 is constructed accordingly with a Z-fold of the material web 14. The penultimate segment 12, e.g., a cathode sheet, is deposited from the left and then covered by the material web 14, which moves from right to left in this case. The last segment 13, e.g., an anode sheet, is deposited from the right and initially remains open on the stack. The uppermost segment 13 is preferably not covered by the material web 14 until during the wrapping process.

### LIST OF REFERENCE SIGNS

10 Apparatus
11 Stack
12 Segments
13 Segments
14 Material web
15 Stacking table
16 Stacking position
17 Wrapping apparatus
18 Wrapping position
19 Material web trailer
20 Material web feed device
21 Separating device
22 Trailer holding apparatus
23 Fixing device
24 Conveyor carriage
25 Free end
26 Clamping lever
27 Material web feed device
28 Separating line

1. An apparatus for the energy cell manufacturing industry, for wrapping a stack comprising a plurality of segments and a material web, wherein
the apparatus is configured to form a stack with segments arranged in folds of the material web and to wrap said stack with the same material web,
wherein
the apparatus has a stacking table with a stacking position, on which the stack can be formed, and a wrapping apparatus with a wrapping position, wherein the stack can be wrapped with the same, continuous material web, on the wrapping position, wherein
the apparatus is configured to move the stack from the stacking position to the wrapping position, wherein
the material web is extracted from a material web feed device by the movement of the stack from the stacking position in the direction of the wrapping position, forming a material web trailer,
and to wrap the stack with the material web trailer of the material web in the wrapping position, and wherein
a separating device is provided, which is configured to separate the material web trailer from the material web of the material web feed device so that the material web trailer has a free end.

2. The apparatus according to claim 1, wherein the apparatus comprises a trailer holding apparatus, which is configured to hold the material web trailer and/or the free end of the material web trailer by means of negative pressure.

3. The apparatus according to claim 1, wherein the stacking table comprises a suction surface, which is configured to hold the material web by means of negative pressure.

4. The apparatus according to claim 2, wherein the trailer holding apparatus and/or the wrapping apparatus are configured to move the free end of the material web trailer and the wrapping position toward each other during wrapping with the material web trailer of the stack.

5. The apparatus according to claim 1, wherein the separating device has a hot wire.

6. the apparatus according to claim 1, wherein the separating device has an ultrasonic cutter.

7. The apparatus according to claim 1, wherein the distance between a separating line or cutting edge of the fed material web on the stacking table and the edge of the first segment on the material web of a new stack is less than 50 mm.

8. The apparatus according to claim 1, wherein the apparatus comprises a fixing device, which is configured to fix the material web trailer wrapped around the stack by the wrapping apparatus.

9. The apparatus according to claim 1, wherein the apparatus has a conveyor carriage, which can be meshed with the stacking table for transferring the stack to the conveyor carriage and with the wrapping apparatus for transferring it to the wrapping apparatus.

10. The apparatus according to claim 9, wherein the conveyor carriage has a clamping lever, which is configured to clamp a stack on the conveyor carriage.

11. The apparatus according to claim 9, wherein the conveyor carriage is movable from the stacking position to the wrapping position.

12. The apparatus according to claim 9, wherein the material web can be extracted from a material web feed device by the conveyor carriage, forming the material web trailer.

13. The apparatus according to claim 12, wherein the material web runs over the empty stacking table by the movement of the conveyor carriage to the wrapping position.

14. A method for the energy cell manufacturing industry, for wrapping a stack comprising a plurality of segments and a material web, wherein said method comprises the following steps:
forming a stack with segments, arranged in folds of the material web, at a stacking position on a stacking table;
moving the stack from the stacking position to the wrapping position and extracting the material web from a material web feed device by the movement of the stack from the stacking position in the direction of the wrapping position, forming a material web trailer;
wrapping the stack with the material web trailer of the material web in the wrapping position by a wrapping apparatus, and
separating the material web trailer from the material web of the material web feed device and producing a free end of the material web trailer, wherein the stack is first wrapped and the material web is then separated, or wherein the material web is first separated and the stack is then wrapped, or wherein the material web is separated and the stack is wrapped at least partially in parallel.

15. The method according to claim 14, wherein the start of the deposition of segments of a new stack onto the material web on the stacking table takes place before the start of the wrapping of the previous stack.

16. The method according to claim 14, comprising the step of:
holding the material web by a trailer holding apparatus.

17. The method according to claim 14, comprising the step of:
holding the material web by a suction surface of a stacking table.

18. The method according to claim 16, wherein the material web trailer is separated from the material web of the material web feed device when the material web is held by the trailer holding apparatus and by the suction surface of the stacking table, wherein the separation takes place between the suction surface of the stacking table and the trailer holding apparatus.

19. The method according to claim 14, comprising the step of:
moving the free end of the material web trailer and the wrapping position toward each other during wrapping of the stack with the material web trailer by moving the trailer holding apparatus and/or the wrapping apparatus.

20. The method according to claim 17, wherein the material web trailer is separated from the material web of the material web feed device when the material web is held by the trailer holding apparatus and by the suction surface of the stacking table, wherein the separation takes place between the suction surface of the stacking table and the trailer holding apparatus.
